(19) United States
(12) Patent Application Publication
(10) Pub. No.: US 2011/0042530 A1
(43) Pub. Date: Feb. 24, 2011

(54) FLEXIPOD WITH FLEXIBLE BENDABLE LEGS WITH A GRIPPING SURFACE

(76) Inventors: Mark Phillips, Longmont, CO (US); Craig Norman, Thornton, CO (US); Natasha M. Adams, Rochester, NY (US)

Correspondence Address: Raymond L. Owens;Patent Legal Staff, Eastman Kodak Company, 343 State Street, Rochester, NY, 14650-2201, US

(21) Appl. No.: 12/793,706

(22) Filed: Jun. 4, 2010

Related U.S. Application Data
(60) Provisional application No. 61/235,247, filed on Aug. 19, 2009.

(51) Int. Cl. F16M 11/06; F16M 11/04

(52) U.S. Cl. 248/121

(57) ABSTRACT

A flexipod is provided. The flexipod device includes at least one flexible, bendable leg with a grippable surface. In one embodiment, the flexible and bendable legs comprise a first continuously flexible and bendable solid core material and a second sheath material which substantially encloses the first core material. Embodiments of the present invention can be bended, twisted, or otherwise manipulated to selectively secure the flexipod to objects having various shapes and sizes. The flexible and bendable legs increase the flexipods versatility and overall securability.

### CROSS REFERENCE TO RELATED APPLICATIONS

This application claims the benefit of U.S. Provisional Patent Application No. 61/235,247, filed Aug. 19, 2009, which is incorporated herein by reference in its entirety.

### FIELD OF THE INVENTION

The present invention is generally related to a flexipod device adapted to support an instrument for use in a plurality of applications. More specifically, embodiments of the present invention are configured as tripods, bipods and monopods that include flexible, bendable legs with a grippable surface that enhance the versatility and securability of the flexipod, and which is adapted for use with a device, such as a camera or telescope.

### BACKGROUND OF THE INVENTION

Typically, tripods are configured with three rigid or semi-rigid legs and a head for mounting an instrument, such as a telescope, camera, or other optical/recording instruments. The tripods are positioned and used on substantially flat or stable surfaces, such as the ground or a table. As such, conventional tripods are difficult to position or secure to objects having a small size, an irregular shape, or to objects that are unstable/moving. It is often necessary or desirable, however, to securely position a tripod on a small or irregularly shaped object, such as a chair, a tree, a light post, a railing or a fence. Additionally, conventional tripods are often awkward to maneuver and set up. For example, conventional tripods are inflexible and minimally adjustable which can substantially interfere with a person's ability to easily maneuver/operate the tripod and any instrument associated therewith.

The Joby company of San Francisco, Calif. has developed a series of “Gorillapod” tripods having flexible legs formed using a series of interconnected ball joint linkages. Aspects of these devices are described in U.S. Patent Application Publication 2007/0154254 to Bevirt, entitled “Mounting apparatus using ball and socket joints with gripping features,” and U.S. Patent Applications Publication 2008/0093516 to Bevirt, entitled “Mounting apparatus using ball and socket joints with composite connectors.” Similar designs have been introduced by other companies including The Sound Professionals of Hainesport, N.J. A monopod variation is disclosed in U.S. Patent Application Publication 2008/0056808 to Bevirt, entitled “Monopod mounting apparatus.”

U.S. Patent Application Publication 2008/0267613 to Darrow, entitled “Apparatuses and systems for supporting and positioning cameras and other equipment,” discloses a tripod having flexible legs including an elongated bendable core passing through a plurality of shaped outer portions.

U.S. Patent Application Publication 2010/0021155 to Orzek et al., entitled “Flexible, positionable and grasping camera or other device mount apparatus,” discloses a tripod featuring flexible legs having an articulating endoskeleton wrapped with dense foam for added protection.

While the above designs for tripods having flexible legs have the advantage of being easily repositionable and adaptable to a wide variety of mounting configurations, they have the disadvantage of being complex and expensive to manufacture due to the large number of interconnected parts required to fabricate the flexible legs.

It would be advantageous to provide a flexipod device that is adjustable, securable and easy to use. Thus, there is a long felt but unsolved need for a simple and inexpensive flexipod device with flexible and bendable legs having a grippable surface.

### SUMMARY OF THE INVENTION

It is one aspect of the present invention to provide a flexipod. More specifically, the flexipod of one embodiment of the present invention is configurable as a tripod, bipod or monopod and provides flexible, bendable legs having a grippable surface. The legs of one embodiment of the present invention are capable of being twisted and secured to objects of various size and shape. Preferably, the flexipod's legs are flexible and bendable to increase the adjustability and maneuverability of the flexipod. In addition, the legs preferably provide a grippable surface so that the flexipod can be selectively secured to objects having different shapes and sizes. In one embodiment of the present invention, the legs preferably include a metal core surrounded by a foam sheath. The foam sheath may include a rubber or plastic surface which may also be textured to prevent slippage. Further, the flexipod of one embodiment of the present invention is lightweight, easy to use, and inexpensive to manufacture.

It is another aspect of the present invention to provide a flexipod having a head or attachment means that is adapted to receive a variety of different devices, such as a camera, spotting scope, or other instrument. The head of one embodiment of the present invention is capable of rotating, tilting, and swiveling to increase the versatility and adjustability of the flexipod. In one embodiment of the present invention, the head preferably includes a ball socket adapted for interconnecting the head to the flexipod legs.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements or components in this Summary of the Invention. Additional aspects of the present invention will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description given below, serve to explain the principles of these inventions.

FIG. 1 is a perspective view of a flexipod in a tripod configuration according to one embodiment of the present invention;

FIG. 2 is a perspective view of a flexipod in a monopod configuration according to one embodiment of the present invention;

FIG. 3 is a perspective view of a flexipod in a monopod configuration, shown positioned around an object;

FIG. 4 is a perspective view showing the construction of a flexipod leg according to one embodiment of the present invention; and

FIG. 5 is a cross sectional view of a flexipod leg according to one embodiment of the present invention;

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION OF THE INVENTION

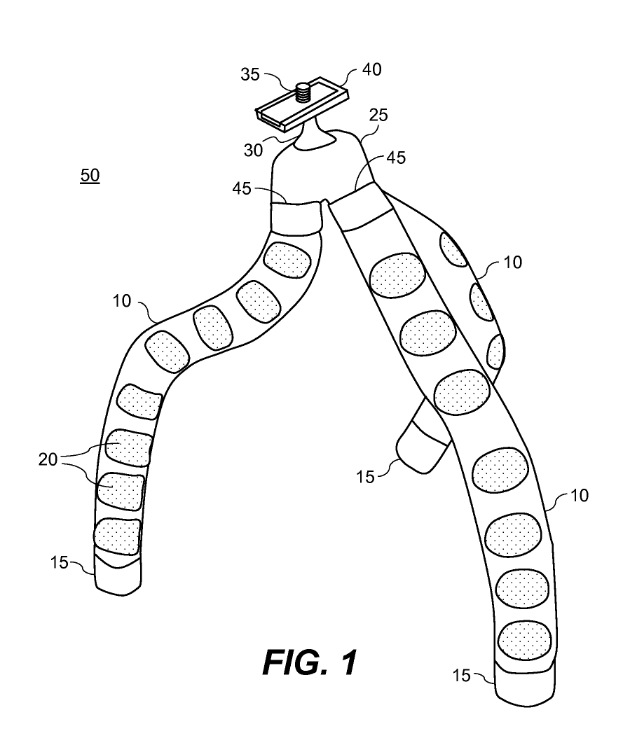

Referring now to FIGS. 1-3, flexipod devices are shown. More specifically, flexipods having flexible, bendable, and grippable legs of one embodiment of the present invention are shown. One skilled in the art will appreciate that the flexipod device of the present invention may be used in many fields and for a broad range of applications requiring or desiring a stable support surface, such as, photography, film, astronomy, surveying, surveillance, hunting, and the like.

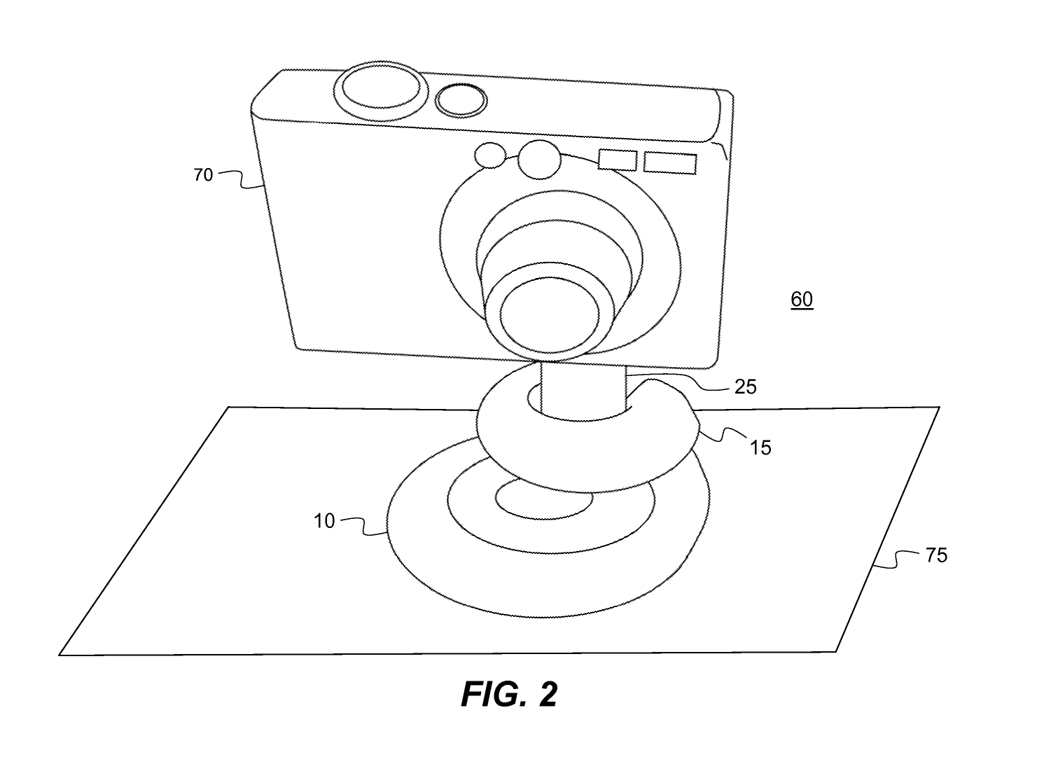

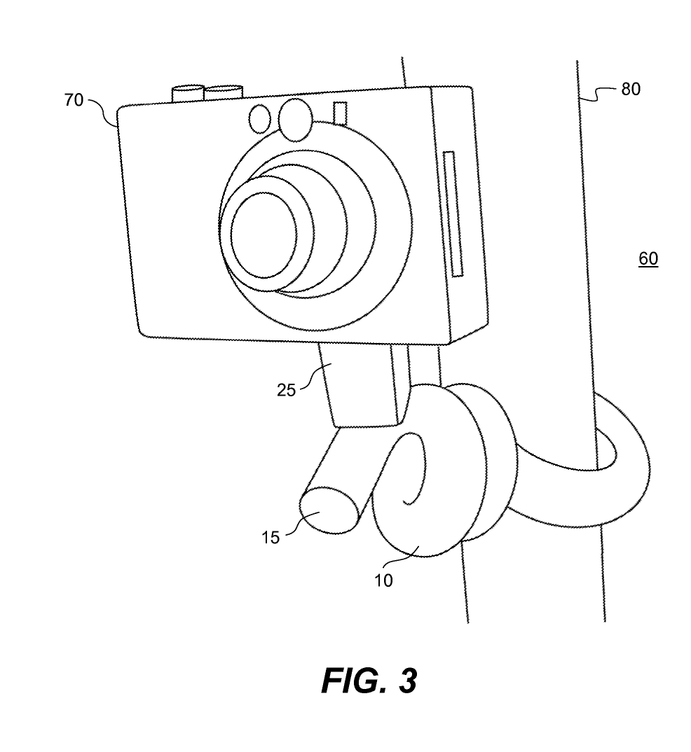

FIG. 1 shows one embodiment of the present invention where the flexipod is a tripod 50 and includes three legs 10. FIGS. 2-3 show an alternate embodiment where the flexipod is a monopod 60 and has one leg 10. FIG. 2 shows how the monopod 60 can be used to position a camera 70 on a flat surface 75. FIG. 3 shows how the monopod 60 can be used to position a camera 70 by wrapping the leg 10 around an object 80, such as a small tree, railing, or light pole.

One of skill in the art will appreciate that the flexipod may be configured to have any number of legs 10 depending on the application, and the invention is not limited to any specific configuration of legs 10. The legs 10 are preferably long enough so that, when positioned, the legs 10 can be twisted around objects of various sizes. The legs 10 are also preferably short enough so that, when not in use, the flexipod is compact, unobtrusive and easy to store.

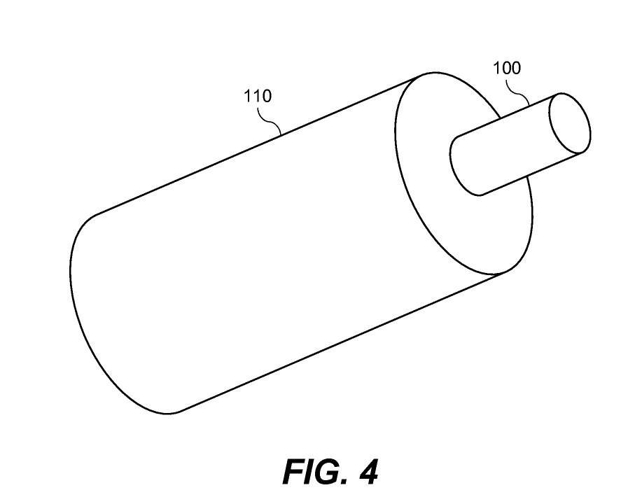

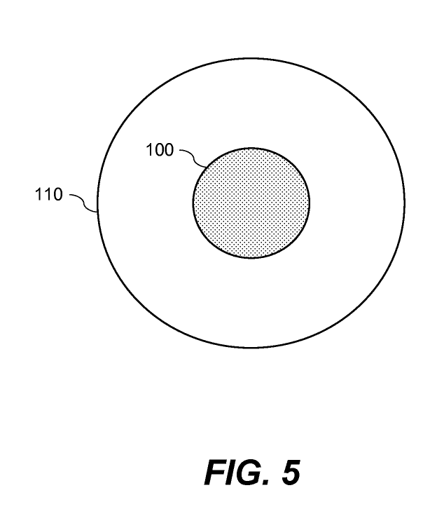

The flexipod's legs 10 are elongated, flexible and bendable. Moreover, the flexipod's legs 10 are preferably flexible and bendable and capable of being bent in a multitude of directions. Referring now to FIGS. 4 and 5, additional features of the flexipod's legs 10 are shown. FIG. 4 is a perspective view illustrating the interior construction of a flexipod leg according to a preferred embodiment of the present invention. FIG. 5 shows a cross-sectional view of a flexipod leg 10.

The diameter of the leg 10 is preferably narrow enough to be wrapped around objects of variable size, such as a small tree, railing, or light pole. The diameter of the leg 10 is also preferably wide enough to be easily manipulated by a user's hand. One of skill in the art will appreciate that each of the legs 10 of the flexipod can have the same diameter or they may also have different diameters.

In a preferred embodiment, the flexipod legs 10 are made of a first core material 100 and a second sheath material 110. More particularly, the core material 100 is a strong yet flexible material that is capable of retaining its shape when bent, such as a flexible metallic wire. One of skill in the art will appreciate that the core material 100 may be made of any suitable elongated flexible metal wire or cable, and the rigidity and bendability of the flexipod leg 10 will depend significantly on the type of metal material used, as well as the thickness. Thus, thicker material will be more rigid, while thinner material will be more flexible. In one embodiment, the metallic wire material has a thickness of between about ⅛ inch to 1 inch thick. The second sheath material 110 is a flexible and pliable material, such as a foam rubber, that is capable of being manipulated into different shapes and is also strong enough to support an instrument such as a camera 70 positioned on the flexipod. In a preferred embodiment, the second sheath material 110 is a foam rubber having a non-slip or slip-resistant exterior. The non-slip surface is desirable so that once positioned, the flexipod will stay securely and firmly in place. A non-slip surface is especially advantageous when securing the flexipod to a vertical object. For example, the flexipod can be securely positioned on a tree, light pole, or vertical object and, because of the non-slip exterior, the flexipod will not slide or slip down. One of skill in the art will appreciate that the flexipod may include any number of non-slip or slip-resistant materials, such as rubber, plastic, or a texturized material.

The foam rubber also protects the object to which the flexipod is secured. For example, the flexipod can be secured to a railing and the foam rubber will protect the railing from being scratched, nicked or otherwise damaged. Alternatively, the flexipod can be used without securing it to anything. That is, the flexipod can be adjusted and used without the flexipod being secured to another object. For example, the flexipod may be positioned and used on a flat surface 75, such as a table, without securing the flexipod to the flat surface as shown in FIG. 2. Additionally, the flexipod of one embodiment of the present invention is environmentally friendly in that the flexipod's bendable and grippable legs 10 may be secured to a living organism, such as a plant or tree, while not damaging or only minimally damaging the organism, its ecosystem, and the environment.

The foam rubber also provides an easily grippable and graspable surface. A flexipod having legs 10 with an easily grippable surface is desirable because it facilitates quick and easy set-up and take-down. Moreover, an easily grippable and graspable surface makes this flexipod easily usable by persons having limited dexterity. One of skill in the art will appreciate that the flexipod may include any number of other grippable features, such as ergonomic finger grips 20 or grip tape.

In addition to being non-slip and grippable, the exterior of the flexipod's legs 10 may be treated with a waterproof or other weatherproof coating. One of skill in the art will appreciate that a flexipod having legs 10 that are waterproof and weatherproof facilitates the flexipods usefulness in outdoor settings. It is envisioned that the flexipod of the present invention could be used with a waterproof camera for water activities, such as boating, fishing, and kayaking. For example, a waterproof camera may be mounted to the flexipod and the waterproof legs 10 may be wrapped around a boat's mast or other structure and the user would have a stable and secure way to take pictures on the boat. Moreover, the grippable exterior of the flexipod's legs 10 would help the flexipod remain securely positioned, even when wet.

For some applications, it may be desirable to attach the flexipod to an object that is difficult or impossible to wrap the flexible and bendable legs 10 around. Thus, in some embodiments of the present invention, the flexipod includes at least one suction cup (not shown) adapted to attach the flexipod to an object, such as a glass door, window, or table.

In still further embodiments of the present invention, the exterior of the flexipod may also include a camouflaging material or camouflaged exterior. One of skill in the art will appreciate that a flexipod having camouflaging qualities is advantageous for many fields requiring or desiring that the flexipod be concealed or undetected, such as hunting and surveillance.

In another embodiment of the present invention, the exterior of the flexipod's legs 10 may include more than one textured material. For example, in one embodiment of the present invention, the exterior of the flexipod's legs 10 may have a first textured material and a second textured material having cut-outs or finger grips 20. The dual-texture exterior provides enhanced grippability for the user. One of skill in the art will appreciate that the exterior of the flexipod's legs 10 may include any number of textured materials known to those skilled in the art to increase the grippability and graspability of the flexipod's legs 10.

In other embodiments of the present invention, a flexipod leg 10 may optionally include a third, vibration or shock absorbing material (not shown) so that less vibration is transferred to a camera or other instrument mounted to the flexipod. One of skill in the art will appreciate that any number of anti-vibration or shock absorbing materials may be incorporated into the flexipod's legs 10, such as a silicone gel pad or Sorbothane sheet. A flexipod capable of absorbing vibrations is desirable for many applications. For example, the flexipod having vibration absorbing material of the present invention may be mounted to an off-road or all-terrain vehicle so that a user can achieve a higher picture/film quality while shooting/filming on rough or unsteady terrain.

Referring back to FIGS. 1-3, each flexipod leg 10 has a top portion and a bottom portion. The top and bottom portions of the leg 10 may be interconnected to end caps. In a preferred embodiment, the bottom end cap is a foot 15. One of skill in the art will appreciate that the feet 15 can be made of any material having anti-skid, anti-slip, or other traction enhancing properties. The feet 15 are preferably made of a rubberized, plastic, or treaded material. In other embodiments, the feet 15 may have additional features, such as attachable or retractable spiked feet (not shown) for securing the flexipod to the ground. In another embodiment of the present invention, the flexipod's legs 10 are extendable. More specifically, in some embodiments, a flexipod leg 10 includes a leg extender (not shown) that is integrated into the leg 10 or that is attachable to the leg 10 via an attachment device. In still further embodiments of the present invention, the feet 15 may include a suction cup (not shown) to selectively secure the flexipod via suction to a smooth object, such as glass. In a preferred embodiment, the top end cap is configured as a ball or other spherical object.

The top end cap of the flexipod's legs 10 is interconnected to at least one head 25. In a preferred embodiment, the flexipod includes one head 25. However, one of skill in the art will appreciate that the flexipod may be configured to have any number of heads 25 or other interconnection surfaces depending on the number of instruments to be secured to the flexipod. The head 25 may be made out of any number of materials, such as plastic, metal, or other sufficiently strong material.

In a preferred embodiment, the head 25 has at least one ball socket. The ball socket is configured to receive a top end cap of a flexipod leg 10. In a more preferred embodiment, the head 25 includes three ball sockets adapted to receive the three top end caps of the flexipod's legs 10. The top end caps are interconnected to the ball sockets to form a ball joint 45. However, one of skill in the art will appreciate that any number of connections, such as pivot joints, swivel joints, or other rotatable connection, may be used to interconnect the flexipod legs 10 to the flexipod head 25. The ball joints 45 allow the head 25 to achieve a wide range of tilt angles. As such, the head 25 may be tilted in an upward or downward direction. In addition, the ball joints 45 allow the flexipod's legs 10 to rotate in 360 degrees. Thus, the ball joints 45 provide a wide range of motion and consequently provide a versatile flexipod that is capable of being adjusted and secured to countless objects.

The head 25 is interconnected to a rotatable extension member 30. The rotatable extension member 30 is adapted to move through some range of motion. One skilled in the art will appreciate that the rotatable extension member 30 may be interconnected to the head 25 by any rotatable connection, or alternatively by a bracket or other assembly having multiple positions of use. In the embodiment shown, the rotatable extension member 30 is capable of rotating 360 degrees. The rotatable extension member 30 is preferably short enough so that the flexipod remains compact and unobtrusive. However, in another embodiment, the rotatable extension member 30 may be long enough to further increase the flexipod's versatility by allowing the instrument to be mounted at some distance away from the head 25 of the flexipod. It is further envisioned that the rotatable extension member 30 may be telescoping or accordion-like so as to provide the user with an adjustable extension member 30. In still further embodiments of the present invention, the flexipod may not include an extension member 30.

The extension member 30 is interconnected to a mount 40. The mount 40 may be integrated with the head 25 or it may be detachable from the head 25. The mount 40 is adapted for securing an instrument or other object to the flexipod. One skilled in the art will appreciate that the mount 40 may also include a mounting screw 35 or other mechanical fastening device, such as a bolt, clamp, or pin. In a preferred embodiment, the mount 40 includes a mounting screw 35 for securing an object to the flexipod. The mounting screw 35 may also have an arm protruding therefrom for increasing the amount of torque that may be applied to the mounting screw 35 and for providing a fastening device that is easy to operate and manipulate. The mount 40 may be configured as a plate, a clamp, snap-fit or other interface configured for attaching an object to the flexipod. The mount 40 may be selectively interconnected to an instrument, such as a camera, video camera, telescope, binoculars, theodolites, firearms, or other object to be secured to and supported by the flexipod. In a preferred embodiment, the mount 40 is selectively interconnected to a camera 70.

In other embodiments of the present invention, the head 25 may be interconnected to the legs 10 by various other attachment means. For example, the head 25 may be interconnected to the legs 10 by glue, a bracket or a compression fit, depending on the application, and the invention is not limited to any specific attachment mechanism.

In one embodiment of the present invention, the flexipod is a tripod 50 as shown in FIG. 1 and is used by positioning an instrument (or some other object) on the mount 40. The instrument is then secured to the mount 40 by the mounting screw 35 or another fastening device. The flexipod is then positioned on or around an object by straightening, bending, or otherwise manipulating and adjusting the flexipod's legs 10. The flexipod is easily set-up and broken-down because of the flexible, bendable, and grippable nature of the flexipod.

In another embodiment of the present invention, the flexipod is a monopod 60 and is similarly used. As shown in FIGS. 2-3, a camera can be mounted on the monopod 60 and the leg 10 can be bent, twisted, and wrapped around a variety of objects to selectively secure the monopod 60 on or around the object.

In addition, the flexipod of at least one embodiment of the present invention is lightweight and easily transportable. For example, a photographer may more easily take a flexipod with him or her when hiking to remote locations, if the camera equipment, such as the flexipod of the present invention, is lightweight and compactable. In another example, a photographer may take more pictures from more locations when the flexipod is capable of being quickly set-up and broken-down and is easily transportable. Moreover, the flexipod of the present invention can be inexpensively manufactured because it is made using readily obtainable components.

While various embodiments of the present invention have been described in detail, it is apparent that modifications and alterations of those embodiments will occur to those skilled in the art. Moreover, references made herein to “the present invention” or aspects thereof should be understood to mean certain embodiments of the present invention and should not necessarily be construed as limiting all embodiments to a particular description. However, it is to be expressly understood that such modifications and alterations are within the scope and spirit of the present invention, as set forth in the following claims.

### PARTS LIST

10 leg
15 foot
20 finger grips
25 head
30 extension member
35 mounting screw
40 mount
45 ball joint
50 tripod
60 monopod
70 camera
75 flat surface
80 object
100 core material
110 sheath material

1. A flexipod, comprising:
at least one flexible and bendable leg, comprising:
a first continuously flexible and bendable solid core material; and;
a second sheath material which substantially encloses said first core material;
at least one head interconnected to said at least one flexible and bendable leg;
a extension member interconnected to said head;
at least one mount interconnected to said rotatable extension member which is adapted to receive an instrument;
wherein the at least one leg is adapted to wrap around an object, and wherein the at least one leg is adapted to support the instrument when mounted to the flexipod.

2. The flexipod of claim 1, wherein the first core material is a flexible metallic wire and wherein the second sheath material is a foam rubber.

3. The flexipod of claim 1, wherein the second sheath material comprises at least one of a foam rubber, a plastic, a nylon, or a combination thereof.

4. The flexipod of claim 1, further comprising a coating material on the second sheath material.

5. The flexipod of claim 4 wherein the coating material is waterproof.

6. The flexipod of claim 1, wherein the flexipod is a monopod having one leg.

7. The flexipod of claim 1, wherein the flexipod is a tripod having three legs.

8. The flexipod of claim 1, wherein the head is capable of rotating, tilting or swiveling.

9. The flexipod of claim 1, wherein the at least one head includes at least one ball socket adapted for interconnecting the head to the at least one flexible and bendable leg.

10. The flexipod of claim 1, further including at least one suction cup adapted to attach the flexipod to a smooth surface.

11. The flexipod of claim 1, wherein grippable features are formed into the second sheath material for at least one of the flexible and bendable legs.

12. The flexipod of claim 1, wherein the extension member is rotatable.
